(19) United States
(12) Patent Application Publication
(10) Pub. No.: US 2014/0087013 A1
(43) Pub. Date: Mar. 27, 2014

(54) Electro-Spinning Nozzle Pack and Electro-Spinning System Comprising the Same

(71) Applicant: WOOREE NANOPHIL CO., LTD., Gyeonggi-do (KR)

(72) Inventors: Dae Keun Park, Gyeonggi-do (KR); Suk Won Chun, Gyeonggi-do (KR); Jong Su Park, Gyeonggi-do (KR); Jin Kyu Han, Gyeonggi-do (KR)

(73) Assignee: WOOREE NANOPHIL CO., LTD., Gyeonggi-do (KR)

(21) Appl. No.: 14/022,409

(22) Filed: Sep. 10, 2013

(30) Foreign Application Priority Data
Sep. 21, 2012 (KR) 10-2012-0105279

(51) Int. Cl. B29C 41/00

(52) U.S. Cl. CPC B29C 41/006
USPC 425/7

(57) ABSTRACT

The present disclosure relates to an electro-spinning nozzle pack for receiving and then electro-spinning a solution with a fiber feedstock dissolved therein, comprising a body with a solution receiving space to keep the solution supplied, a plurality of solution injection nozzles installed at the body in such a manner that the nozzles are in communication with the solution receiving space, and a high-voltage electrode arranged inside the solution receiving space, for charging the solution therein; and to an electro-spinning system comprising such an electro-spinning nozzle pack.

### CROSS-REFERENCE TO RELATED APPLICATIONS

This application claims the benefit and priority of Korean Patent Application No. 10-2012-0105279, filed Sep. 21, 2012. The entire disclosure of the above application is incorporated herein by reference.

### FIELD

The present disclosure relates generally to an electro-spinning nozzle pack, and an electro-spinning system comprising the same; and more particularly, to an electro-spinning nozzle pack having a high-voltage electrode embedded in a solution receiving space inside of the pack, and an electro-spinning system comprising such an electro-spinning nozzle pack.

### BACKGROUND

This section provides background information related to the present disclosure which is not necessarily prior art.

Electro-spinning is a technology that spins a solution of fiber feedstock in its charged state to produce fibers of very small diameters. Lately, electro-spinning has been used as a technology for producing nanometer grade fibers, and the relevant studies are under active progress. Fibers that are produced by electro-spinning have a diameter or thickness ranging from micrometers to nanometers. When the fibers have a small thickness, they exhibit new superior characteristics, such as an increase in the surface area-to-volume ratio, improved surface functionality, enhanced mechanical properties including tension, and so on. These superior characteristics allow the nanofibers to be used in a number of important applications. For instance, a web made of such nanofibers may be applied as a porous separator material in diverse fields, including various types of filters, breathable (moisture-permeable) waterproof fabrics, medical wound care dressings, scaffolds and so on.

FIG. 9 is a view showing one example of an electro-spinning apparatus.

The electro-spinning apparatus 40 includes a supply unit 110, a spinning unit 120, a collector 130, control units 140, an induction unit 150, and an air conditioning unit 160.

The supply unit 110 supplies a polymer solution for use as a fiber feedstock. The spinning unit 120 has a plurality of spinning nozzles 122 for ejecting the polymer solution supplied from the supply unit 110 in the form of a charged filament or fiber. The collector 130 is disposed at a certain distance away from the spinning nozzles 122 so as to pile up those spun filaments from the spinning unit 120 to a given thickness. The control units 140 are installed, at least, on both sides of the spinning unit 120. The induction unit 150 is positioned between the control units 140 and the collector 130, surrounding a filament stream. The air conditioning unit 160 injects air into the space between the spinning unit 120 and the collector 130, and evaporates a solvent in this space to allow the solvent to be discharged to the outside.

The supply unit 110 includes a storage container 112, a pump 114, a distributor 116, and a transfer line 118.

The storage container 112 stores a solution with a polymer material dissolved therein to make a fiber feedstock. The pump 114 pressurizes the solution contained in the storage container 112 in such a manner that a fixed amount of the solution is dispensed towards the spinning unit 120. The distributor 116 and the transfer line 118 distribute the solution to the respective nozzles.

The spinning unit 120 spins the charged fiber feedstock solution supplied from the supply unit 110, towards the collector 130, in the form of a fine filament. The spinning unit 120 has at least one spinning nozzle pack 126 in which a plurality of spinning nozzles 122 is arranged. The number of the spinning nozzles 122 which constitute the spinning nozzle pack 126 or the number of the spinning nozzle packs 126 that constitute the spinning unit 120 is determined by comprehensively taking the size, thickness and production rate of webs to be produced into account. In case of spinning several polymer materials, separate spinning nozzles may be provided.

The collector 130 can be grounded to have a potential difference with respect to a voltage applied to the spinning unit 120, or a negative (−) voltage can be applied thereto. The collector 130 piles up those charged filaments ejected from the spinning unit 120. For example, the collector 130 may be configured as a conveyor belt type provided with a transport means, e.g., rollers 132, for continuous movement.

The control units 140 are installed at least on both sides of the spinning nozzle pack 126, along the longitudinal direction of the pack. The control unit 140 prevents the filament stream spun from the respective spinning nozzles 122 from deviating from its path, e.g., repulsing each other and spreading.

A voltage of the same polarity as that of the control units 140 is applied to the induction unit 150. The induction unit 150 is installed around the stretched, charged filament stream and guides the flow direction of the filament stream. The induction unit 150 can be in the form of a conducting plate or a conducting bar. The induction unit 150 is charged with the same polarity as that of the charged filament, thereby inducing the filament to be piled up in a defined area on the upper surface of the collector 130.

The air conditioning unit 160 has a solvent suction/exhaust means such as a suction fan and an exhaust fan, and a plurality of air inflow slots 162. The air conditioning unit 160 volatilizes the solvent dissolved in the charged filament in the space between the spinning unit 120 and the collector 130, and ventilates it to the outside.

The high-voltage unit 170 outputs a DC voltage in the range from 10 kV to 120 kV. A positive (+) voltage is excited by the output voltage of the high-voltage unit 170.

When the feedstock solution kept in the supply unit 110 is dispensed to the spinning unit 120 by means of the pump 114 and the distributor 116, the solution is discharged by a current carrying part within each spinning nozzle pack 126 of the spinning unit 120. The charged solution then passes through a capillary tube of the spinning nozzle 122, whereby it is then discharged in the form of a fine filament towards the collector 130. Here, the filament is stretched and spun by a strong electric field formed between the collector 130 and the charged filament, until the filament has a nano-sized diameter.

In this spinning process, as the filament stream tends to deviate from its path and spread outward, the control unit 140 ensures that the filament stream returns to its original position and is kept in the correct flowing path.

Further, the induction unit 150 is installed on top of the collector 130 in such a manner that it surrounds the filament stream being ejected. The induction unit 150 induces, to a defined pile-up area on the collector 130, the filament stream that would deviate from its path. These filaments induced as above are continuously piled up on the conveyor belt or rotary drum type collector 130, or on the upper surface of a substrate 182 such as a film, a vellum paper, a non-woven fabric transported by the roller 180, thereby producing a web with a porous film made from nanofibers. One example of such electro-spinning apparatus is presented in U.S. Pat. No. 7,351,052.

In an electro-spinning system according to the prior art, an electrode is connected directly to the body of a spinning nozzle pack such that a current flows across the solution supplied into the solution receiving space. Because of this, the magnetic field leaks out of the body of the spinning nozzle pack, resulting in an electro-spinning operation which is neither smooth nor stable. Additionally, a relatively higher voltage should be applied to compensate for the magnetic field leakage.

Moreover, the electro-spinning system according to the prior art has adopted a method where a wire is grounded to the pipe for the solution to be injected to the spinning nozzle pack, because a wire cannot be connected directly to those numerous solution injection nozzles. With this method, even a higher voltage must be applied because the polymer solution itself serves as an electrical resistor and an applied voltage should pass this resistor in order to feed the electricity to the solution injection nozzles. Accordingly, this high voltage increases a risk of accidents and lowers the stability of the spinning operation. Furthermore, the voltage applied to the solution not only flows in the injection direction of the solution injection nozzles, but it also flows backwards along the solution pipe, possibly causing an accident and a leakage current.

Also, the traditional electro-spinning system produces fibers by spinning several grams of a solution per hour in at least one injection nozzle. This leads to a very slow production rate.

In addition, the extensibility of the spinning nozzle pack in the longitudinal direction is rather poor, as a solution inlet and a gas inlet are arranged at both ends in the longitudinal direction of the body of the spinning nozzle pack. For instance, when more spinning nozzle packs are connected in the longitudinal direction for mass production, two injection nozzles located at the respective tips of two neighboring spinning nozzle packs are brought closer to each other such that the gap therebetween becomes greater than the gap between the injection nozzles provided in a spinning nozzle pack. Therefore, it is practically impossible to mass produce uniform nanofibers for a large area substrate.

Considering that nano-sized fibers are produced by discharging a very small amount of solution, the use of such a small amount of solution brings unsatisfactory results in the area of a web produced therefrom and the production rate.

### SUMMARY

The problems to be solved will be described in the latter part of the detailed description.

This section provides a general summary of the disclosure and is not a comprehensive disclosure of its full scope or all of its features.

According to an aspect of the present disclosure, there is provided an electro-spinning nozzle pack for receiving and then electro-spinning a solution with a fiber feedstock dissolved therein, comprising: a body with a solution receiving space to keep the solution supplied; a plurality of solution injection nozzles installed at the body in such a manner that the nozzles are in communication with the solution receiving space; and a high-voltage electrode arranged inside the solution receiving space, for charging the solution therein.

According to another aspect of the present disclosure, there is provided an electro-spinning system comprising: an electro-spinning nozzle pack for receiving and then electro-spinning a solution with a fiber feedstock dissolved therein, which comprises a body with a solution receiving space to keep a solution supplied, a plurality of solution injection nozzles installed at the body in such a way to be communicable with the solution receiving space, and a high-voltage electrode arranged inside the solution receiving space for charging the solution therein; a solution supply block for supplying a solution to the solution receiving space; a high-voltage providing block for applying a high voltage to the high-voltage electrode; and a collector on which electrospun fibers from the plurality of solution injection nozzles are piled up.

The advantageous effects of the present disclosure will be described in the latter part of the detailed description.

### BRIEF DESCRIPTION OF DRAWINGS

FIG. 1 is a view schematically illustrating one example of an electro-spinning system according to the present disclosure.

FIG. 2 is a view illustrating one example of an electro-spinning nozzle pack according to the present disclosure.

FIG. 3 is a sectional view taken along line A-A′ of FIG. 2.

FIG. 4 is a sectional view taken along line B-B′ of FIG. 2.

FIG. 5 is an exploded view of one example of an electro-spinning nozzle pack according to the present disclosure.

FIG. 6 is a sectional view taken along line C-C′ of FIG. 2.

FIG. 7 is a sectional view taken along line D-D′ of FIG. 2.

FIG. 8 is an enlarged view of one example of a high-voltage electrode according to the present disclosure.

FIG. 9 is a view illustrating one example of an electro-spinning apparatus.

### DETAILED DESCRIPTION

The present disclosure will now be described in detail with reference to the accompanying drawings.

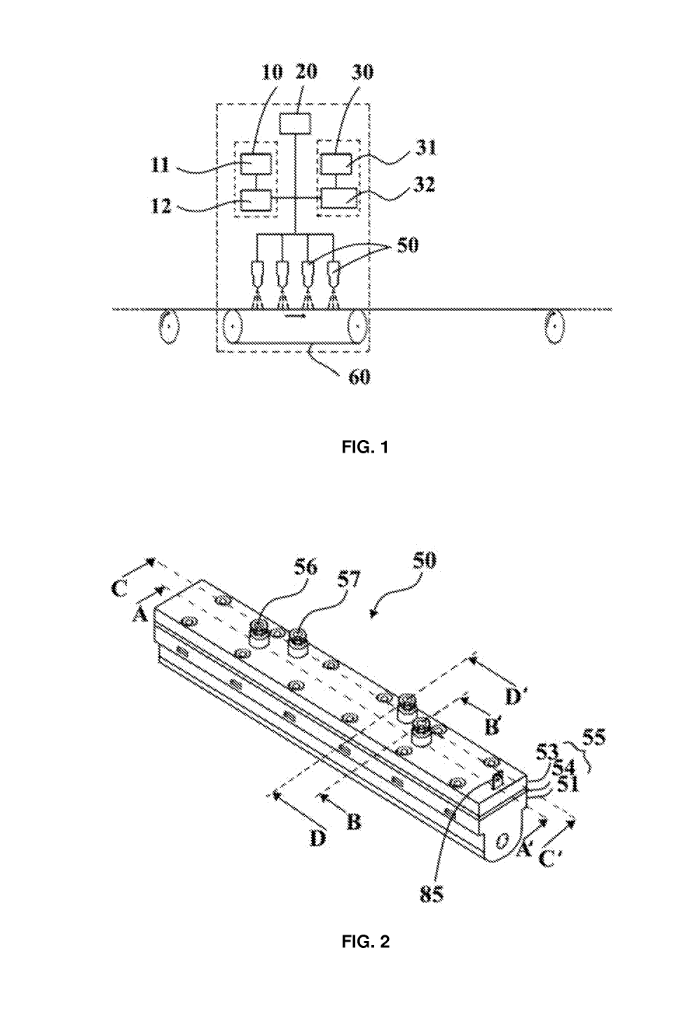

FIG. 1 is a view schematically illustrating one example of an electro-spinning system according to the present disclosure.

The electro-spinning system according to the present disclosure includes an electro-spinning nozzle pack 50, a solution supply block 10, a high-voltage providing block 20, an air supply block 30, and a collector 60.

The electro-spinning nozzle pack 50 receives a solution with fiber feedstock dissolved therein and then electrospins the solution. The solution supply block 10 supplies the solution to the electro-spinning nozzle pack 50. The high-voltage providing block 20 applies a high voltage for charging the solution in the electro-spinning nozzle pack 50. The air supply block 30 supplies a temperature-controlled high-pressure gas. The collector 60 is installed below the electro-spinning nozzle pack 50, and thus the electrospun fibers from the electro-spinning nozzle pack 50 are piled up on the upper surface of the collector 60.

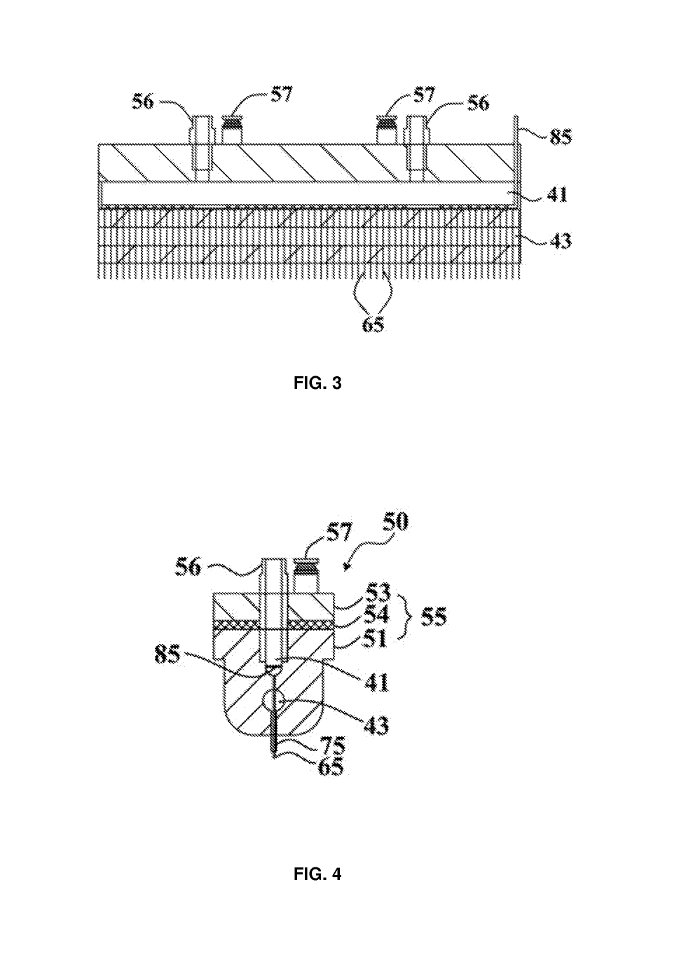

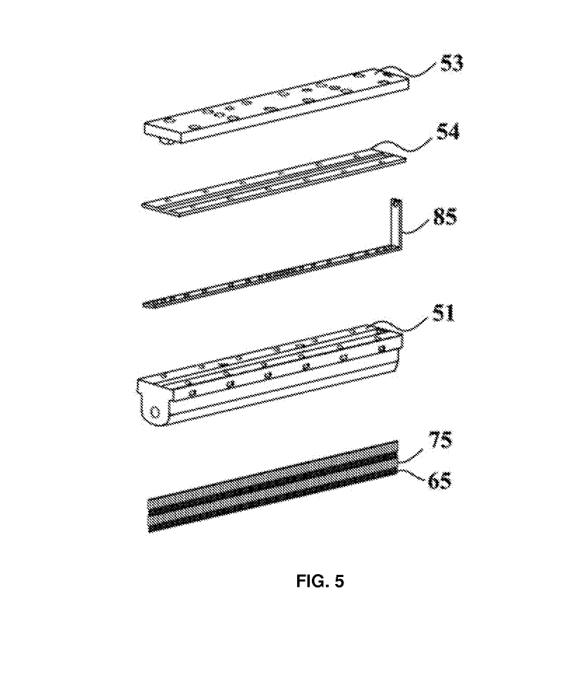

FIG. 2 is a view illustrating one example of an electro-spinning nozzle pack according to the present disclosure, FIG. 3 is a sectional view taken along line A-A′ of FIG. 2, FIG. 4 is a sectional view taken along line B-B′ of FIG. 2, and FIG. 5 is an exploded view of one example of an electro-spinning nozzle pack according to the present disclosure.

As shown in FIG. 2-FIG. 5, the electro-spinning nozzle pack 50 includes a body 55, a plurality of solution injection nozzles 65, a plurality of gas injection nozzles 75 and a high-voltage electrode 85.

The body 55 has, within it, a solution receiving space 41 for keeping the solution supplied, and a gas receiving space 43 for keeping a high-pressure gas. The gas receiving space 43 is located below the solution receiving space 41. The plurality of solution injection nozzles 65 is installed in the body 55 in such a manner that the nozzles 65 are in communication with the solution receiving space 41, e.g., along the longitudinal direction of the body 55. The plurality of gas injection nozzles 75 is installed in the body 55 in such a manner that the nozzles 75 are in communication with the gas receiving space 43. The high-voltage electrode 85 is located inside the solution receiving space 41 to charge the solution therein.

The inner walls of the solution receiving space 41 are preferably tapered downward, forming a gentle slope in a streamline shape, such that the solution may flow down smoothly.

The body 55 has a longish shape in one direction. The body 55 is composed of a lower block 51 and an upper cover 53, making it easier to wash after its use. A preferable material employed for the body 55 is an engineering plastic that can offer chemical resistance, such as, polytetrafluoroethylene (PTFE), polyetheretherketone (PEEK), a polyamide-based polymer like nylon and so forth.

Further, a gasket 54 for sealing is provided between the lower block 51 and the upper cover 53 so as to avoid any leakage of the injected spinning solution. Preferably, the gasket 54 is made of a material selected from the group consisting of various organic and inorganic materials including rubber, silicon, asbestos, synthetic resins and so forth, which are resistant to solvents.

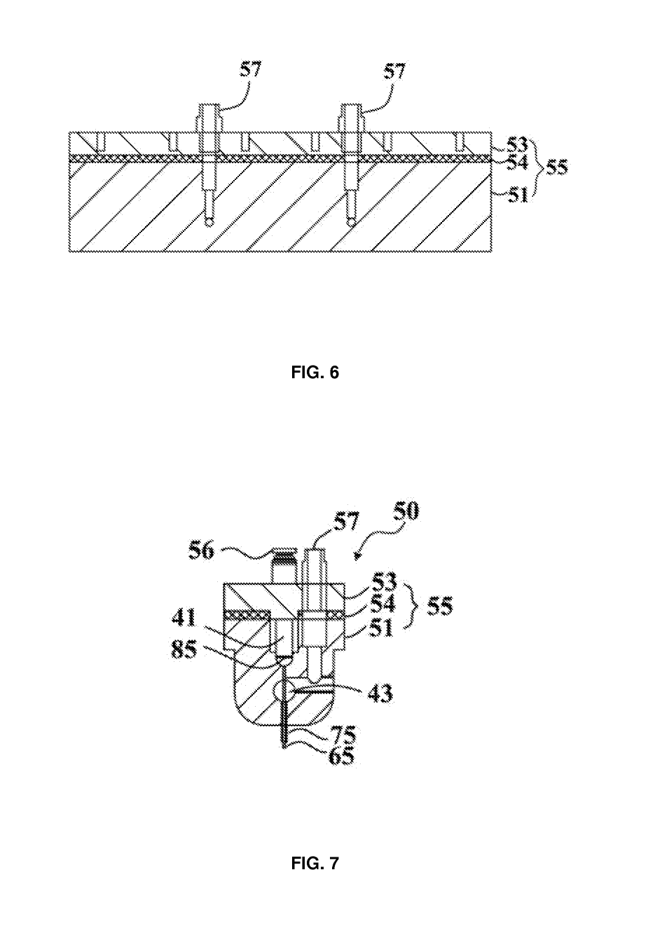

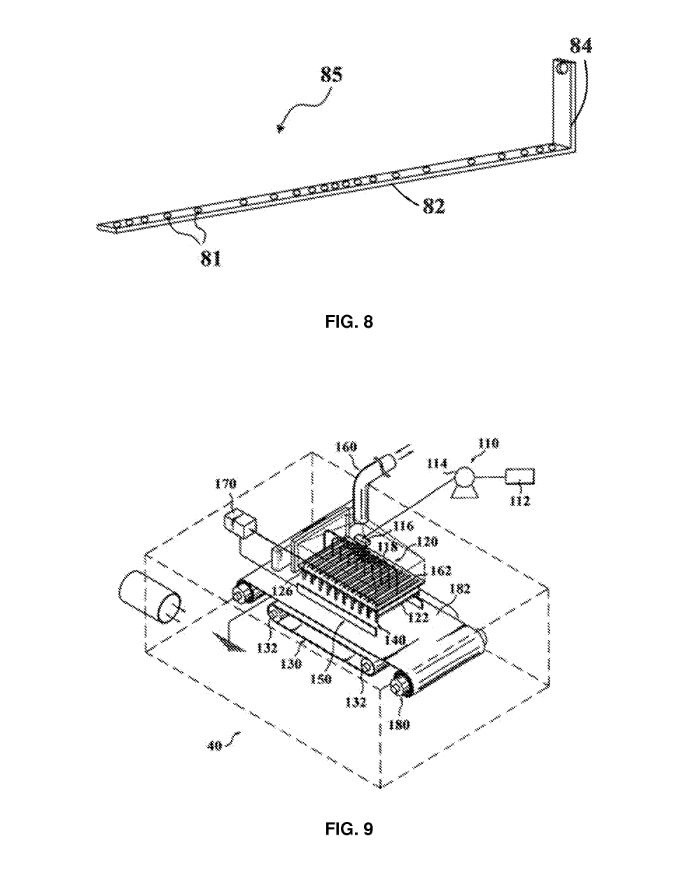

FIG. 6 is a sectional view taken along line C-C′ of FIG. 2, FIG. 7 is a sectional view taken along line D-D′ of FIG. 2, and FIG. 8 is an enlarged view of one example of a high-voltage electrode according to the present disclosure.

The body according to this example has a solution inlet 56 in communication with the solution receiving space 41, and a gas inlet 57 in communication with the gas receiving space 43. The solution inlet 56 and the gas inlet 57 are formed at the upper cover 53 that constitutes the body 55. The solution inlet 56 extends straight down to be in communication with the solution receiving space 41; the gas inlet 57 extends straight down and then horizontally, thereby bypassing the solution receiving space 41 and being in communication with the gas receiving space 43. The solution inlet 56 is connected with the solution supply block 10, and the gas inlet 57 is connected with the air supply block 30.

Accordingly, as the solution inlet 56 as well as the gas inlet 57 are not necessarily formed at the ends of the body 55, e.g., both ends in the longitudinal direction of the body 55, but are formed in such a manner that they are projected upward from the body 55, configurational interference does not occur even when two or more electro-spinning nozzle packs 50 are connected, for example, in the longitudinal direction, for producing a wide fiber web, and this enables them to obtain excellent extensibility.

The solution injection nozzles 65 are arranged in such a manner that their inlets are located at a lower part of the solution receiving space 41 and they extend downward, passing through the gas receiving space 43 until their outlets are projected downward from the body 55.

The gas injection nozzles 75 are arranged in such a manner that they have a one-to-one correspondence with the solution injection nozzles 65 and their inlets are located at a lower part of the gas receiving space 43, extending downward until their outlets are projected downward from the body 55. The gas injection nozzles 75 are disposed so as to encompass the solution injection nozzles 65. As such, the solution injection nozzle 65 passes through the center of the gas injection nozzle 75.

The gas injection nozzles 75 having a one-to-one correspondence with the solution injection nozzles 65 with a uniform spacing therebetween having an aperture that is slightly larger than or equal to the outer diameter of the liquid injection nozzles 65, which creates a tight fitting between the gas injection nozzles 75 and the solution injection nozzles 65. Here, the gas injection nozzles 75 are adapted to enable a flow path forming process for giving a direction to the nanofibers that are spun. Also, when taking the prevention of an electric field interference, the prevention of any contact between the ejected filament streams and an available space in the solution injection nozzle 65 into consideration, a spacing between the solution injection nozzles 65 installed in the electro-spinning nozzle pack 50 is preferably between 1 mm and 50 mm, and more preferably between 3 mm and 30 mm. If the spacing is too small, the electrical interference becomes greater; if the spacing is too large, the production efficiency becomes poor, which results in non-uniform nanofiber webs, making them appear as a stain. In order to spin uniform nanofibers, the solution injection nozzle 65 is preferably structured to have an inner diameter between 0.005 mm and 1.0 mm, an outer diameter between 0.01 mm and 5 mm, and a length of the outwardly projected portion between 0.1 mm and 55 mm. As to the gas injection nozzle 75, a suitable inner diameter is between 0.1 mm and 10 mm, and a suitable length of the outwardly projected portion is between 0.01 mm and 55 mm, but an outer diameter is not particularly limited. Because the gas injection nozzle 75 should accommodate the solution injection nozzle 65 therein, it should have a larger outer diameter than that of the solution injection nozzle 65. Also, because the gas injection nozzle 75 should inject gas from a higher position or from the same height as the outlet of the solution injection nozzle 65, it should have a length shorter than or equal to that of the solution injection nozzle 65.

The gap between the both end faces along the longitudinal direction of the electro-spinning nozzle pack 50 and the solution injection nozzles 65, among those solution injection nozzles 65, which are located on both ends of the electro-spinning nozzle pack 50, is preferably a half of the spacing between two neighboring solution injection nozzles 65. Therefore, when connecting more than two electro-spinning nozzle packs in the longitudinal direction for use, it is possible to maintain uniform spacing between the solution injection nozzles 65 even at the boundary portions between the electro-spinning nozzle packs, and this makes it possible to mass produce uniform nanofibers during the fiber spinning for a large area substrate.

The fiber that is produced by the electro-spinning nozzle pack 50 according to this description may have a varying diameter, by adjusting diverse conditions including the size of a minute hole to be formed in the solution injection nozzle 65.

Using such an electro-spinning nozzle pack 50 according to the present disclosure allows obtaining fibers with a nano-scale diameter which corresponds to the range from 10 nm to 5000 nm, and a web can then be produced by piling up these nanofibers on the collector 60.

Nanofibers that can be produced by employing the electro-spinning nozzle pack 50 according to the present disclosure can be found in a wide range of applications including filter materials, materials for clothing such as moisture-permeable waterproof clothes and protection working clothes, materials for use in bio-medical and tissue-engineering fields, materials for drug delivery, photochemical sensor materials and materials for aesthetic purposes. For example, the nanofiber, having a very large surface area compared to its volume, demonstrates outstanding effects when applied as a filter. Also, the nanofiber, having numerous pores contained therein, demonstrates excellent advantages as a moisture-permeable waterproof material.

As for a material of the solution injection nozzle 65, chemical resistant engineering plastics, including polypropylene (PP), polyethylene, fluoropolymers such as polyvinylidene fluoride and polytetrafluoroethylene, polyetheretherketone, polyamide-based polymers such as nylon, may be employed. As an alternative, corrosion resistant metals such as stainless steel (SUS) may be employed. The solution injection nozzle 65 may be a long conical or bar-shaped hollow nozzle.

The high-voltage electrode 85 is placed inside the solution receiving space 41 in such a manner that the electrode 85 is immersed in the solution. The high-voltage electrode 85 is preferably placed at the bottom side of the solution receiving space 41 so that it may be close to the inlets of the solution injection nozzles 65. The high-voltage electrode 85 can be configured with a conducting plate or a conducting bar which stretches out along the longitudinal direction of the body 55, and preferably does not have any sharp edge portion in order to prevent an electric field from being concentrated on a particular region. More specifically, as illustrated in FIGS. 3, 4 and 8, the high-voltage electrode 85 can have an electrode part 82 placed inside the solution receiving space 41, the electrode part 82 having a longish form to correspond to the planar shape of the solution receiving space 41; and a connecting part 84 extending from one end of the electrode part 82 in an upward direction to be withdrawn outside. Further, a plurality of openings 81 is formed in the electrode part 82. The openings 81 are preferably formed in such a manner that the spacing between the openings 81 below the solution inlet 56 via which the solution is injected is larger, and then the spacing becomes gradually smaller for the openings 81 located farther from the solution inlet 56. With the openings 81 formed in this way, it is possible to substantially reduce a distributional unbalance that occurs as the part where the solution is directly injected ejects more, compared with other parts.

The largest spacing between two openings 81 located below the solution inlet 56 can correspond to the spacing of up to ten solution injection nozzles 65, and the smallest spacing between two openings 81 located farthest from the solution inlet 56 can correspond to the spacing between at least two solution injection nozzles 65. While the opening 81 may have a varying structure depending on the overall size of the high-voltage electrode 85, it preferably has a diameter approximately between 0.5 mm and 20 mm, and a spacing between 5 mm and 50 mm. Thus, considering that the closer the openings 81 are towards the solution inlet 56 the spacing between the openings increases, and the farther the openings 81 are away from solution inlet 56 the spacing between the openings decreases, slight extension of the transfer path of the solution may ensure the uniform distribution to a great extent.

Although FIG. 8 illustrates a high-voltage electrode 85 having a plurality of openings 81 arranged in a row, it is also acceptable that the openings are arranged in two or more rows. As mentioned, when the plurality of openings 81 is arranged in two or more rows, the openings in neighboring rows do not always need to stay in the same line, but they may also be arranged alternately with each other.

It should be understood that the application of the electro-spinning nozzle pack 50 according to this example is not particularly limited to the electro-spinning system according to the present disclosure, but can also be found in a spinning means for conventional electro-spinning systems that produce nanofibers by an electro-spinning process.

The solution supply block 10 serves to supply a solution with a polymer material dissolved therein as a fiber feedstock, and includes a solution storage part 11 and a dispensing transfer pump 12 for supplying a fixed amount of the solution to the electro-spinning nozzle pack 50.

As for the polymer material that composes the solution, all kinds of solvent-soluble polymer materials can be employed. Examples of such polymer materials may include fluoropolymers such as polyvinylidene fluoride (PVDF), acrylic polymers such as polyacrylonitrile (PAN), polyester polymers such as polyethylene terephthalate (PET), polyurethane polymers, polyamide polymers such as Nylon 6, polyether sulfone (PES), polyimide (PI), polyethylene oxide (PEO), which can be used alone or a mixture of at least two thereof.

Examples of a substrate on which the solution is electrospun include a textile fabric, a non-woven fabric, a paper sheet, a film, a glass plate, a ceramic plate, a metallic belt and so forth.

Examples of the dispensing transfer pump 12 for supplying the solution may include, for example, a conventional liquid dispensing pump or peristaltic pump, a gear pump and so forth, which can maintain a fixed amount of the solution to be transferred. In the present disclosure, the amount of the solution to be transferred is determined by the number of solution injection nozzles 65 that are installed and by the ejection amount of a single solution injection nozzle 65. Here, the ejection amount is preferably expressed as a nanoliter per minute or microliter per minute.

Meanwhile, a solution supply line is situated between the solution supply block 10 and the electro-spinning nozzle pack 50, for quantitatively distributing the solution transferred from the dispensing transfer pump 12 into the solution receiving space 41 inside the electro-spinning nozzle pack 50, via the solution inlet 56. Here, the solution supply line may be designed to quantitatively distribute the solution to a single electro-spinning nozzle pack 50, or may be designed in a branched form to quantitatively distribute the solution to a plurality of electro-spinning nozzle packs 50.

The present disclosure is not limited to the structure described above, but it embraces any modification where the solution supply block 10 is connected independently to each electro-spinning nozzle pack 50, for a better quantitative distribution of the solution.

The high-voltage providing block 20 applies a high voltage to the high-voltage electrode 85 and performs, inside the solution receiving space 41, a charging operation on the solution being supplied, by giving an electric charge thereto. In connection with the distance between the outlet of the solution injection nozzle 65 and the collector 60, it is preferable to apply a high voltage between 0.5 kV and 20 kV per unit distance, cm. More preferably, an applied voltage ranges from 1 kV/cm to 10 kV/cm. In order to form a cone jet (this is formed when an electric repulsive force overcomes the surface tension, at a certain threshold electric field intensity) at the outlet of the solution injection nozzle 65, a voltage greater than the surface tension is needed. If an applied voltage is too low, a split (a fiber can be split into strands by an electric repulsive force) cannot be formed; if an applied voltage is too high, on the contrary, it may accompany a rapid drying process and an unstable spinning operation, leading to a higher risk of accidents.

The high-voltage electrode 85 charges the solution after receiving an electric charge from the high-voltage providing block 20. As the high-voltage electrode 85 is located as close as possible to the solution injection nozzles 65, preventing any leakage current to outside, it is unnecessary to increase an applied voltage and as a result thereof, a stable spinning environment can be created. The distance between the high-voltage electrode 85 and the inlet at the upper end of the solution injection nozzle 65 is preferably maintained in a range from 0.1 to 6 mm, and more preferably from 0.5 to 4 mm. If they come closer to each other within a distance of 0.5 mm or less, it may increase the resistance or block the injection of a solution into the inlet of the solution injection nozzle 65; if they are too far away from each other, the resistance still increases.

The air supply block 30 includes a blower 31 for forcefully sending a gas, and a temperature controller 32 for controlling the temperature of the gas. The air supply block 30, which is a device capable of increasing the dryness of spun nanofibers and of controlling the morphology (surface configuration) thereof, is connected to the gas inlet 57 on top of the body 55 of the electro-spinning nozzle pack 50 and is adapted to be able to inject a high-temperature compressed gas through the plurality of gas injection nozzles 75 arranged in a one-to-one-correspondence with the solution injection nozzles 65. The air supply block 30 provides a high-temperature compressed air between 10° C. and 200° C. such that it can control the dryness and morphology of nanofibers. Air at 10° C. or less is not very effective for drying, and a condensation phenomenon may occur while working in a highly humid spinning chamber; air at 200° C. or higher may cause deformation in the spinning pack's body made of a polymeric material.

While it is preferable to apply a vapor of the same spinning solution as a gas to be injected into the gas receiving space 43, it should be appreciated that the gas is not limited thereto. For instance, oxygen, nitrogen, argon, carbon dioxide, volatile solvent or the like can be used as the gas, provided that these gases are preferably moisture-free.

Taking account of the volatility of the solvent, the temperature of a gas injected from the gas injection nozzle 75 is preferably set to a range from 10° C. to 200° C. Moreover, the volume flow of a gas injected from the gas injection nozzle 75 is set, e.g., to a range from 0.1 to 10 kg/cm², such that it does not affect the ejection amount of nanofibers to be spun.

The collector 60 is for a uniform pile-up of the spun nanofibers, and therefore it is adapted to transfer a substrate at a constant speed, while making an electric contact with the substrate. The collector 60 may take a conventional roll, conveyor, drum or disc type structure.

The collector 60 may be grounded, or a voltage of the opposite polarity to that of the voltage applied to the electro-spinning nozzle pack 50 can be applied to the collector 60. For instance, the collector 60 preferably takes the form of a conveyor belt such that the substrate can be supplied continuously to the lower part of the electro-spinning nozzle pack 50 through a transfer means such as a roller. As for the material of the collector 60, it is preferable to use a high conductivity metal plate, but other types of conductive materials can also be employed.

Several embodiments of the present disclosure will now be described.

(1) The body has a gas receiving space below the solution receiving space, for receiving gas, and wherein the electro-spinning nozzle pack further comprises a plurality of gas injection nozzles installed in such a manner that the solution injection nozzles having a one-to-one correspondence with the gas injection nozzles pass through the centers of the gas injection nozzles, respectively.

(2) The body has a gas inlet which is in communication with the gas receiving space, and extends towards the top surface of the body bypassing the solution receiving space.

(3) The high-voltage electrode has a plurality of openings arranged along the longitudinal direction of the body.

(4) The plurality of openings are arranged such that a spacing between the openings below the solution inlet is the largest, and then the spacing becomes gradually smaller for the openings located farther from the solution inlet.

(5) A gap between the solution injection nozzles located on both ends among the solution injection nozzles and the both end faces along the longitudinal direction of the body is a half of the spacing between two neighboring solution injection nozzles.

(6) The body of the electro-spinning nozzle has a gas receiving space below the solution receiving space, for receiving gas; wherein the electro-spinning nozzle pack comprises a plurality of gas injection nozzles installed in the body in such a manner that the nozzles are in communication with the gas receiving space and the solution injection nozzles having a one-to-one correspondence with the gas injection nozzles pass through the centers of the gas injection nozzles, respectively; and wherein the electro-spinning system further comprises an air supply block for supplying air to the gas receiving space.

(7) The air supply block includes a blower for forcefully sending a gas, and a heater for controlling the temperature of the gas.

In an electro-spinning nozzle pack according to the present disclosure, a high-voltage electrode is disposed close to a solution injection nozzle and immersed in the solution, which blocks a magnetic field leakage to outside and enables a stable electro-spinning operation.

In another electro-spinning nozzle pack according to the present disclosure, a high-voltage electrode, solution inlets and gas inlets can be integrated into the electro-spinning nozzle pack, thereby improving the work efficiency.

In still another electro-spinning nozzle pack according to the present disclosure, when two or more electro-spinning nozzle packs for use are connected, an equal spacing between the solution injection nozzles is maintained even at the boundaries between the electro-spinning nozzle packs. This offers a broad width and extensibility advantageous for mass production, e.g., making it possible to mass produce uniform nanofibers during the fiber spinning for a large area substrate.

In an electro-spinning system according to the present disclosure, the use of a temperature-controllable air supply block makes it possible to change the temperature inside the electro-spinning nozzle pack to a desired condition, such that the adjustment of the viscosity of the solution being supplied can be done through the temperature control, and the solution supply can be facilitated. Also, condensation of the air supply system at a low-temperature environment can be resolved.

In another electro-spinning system according to the present disclosure, the use of a temperature-controllable air supply block makes it possible to change the temperature inside the electro-spinning nozzle pack to a desired condition, such that the temperature of the solution receiving space can be maintained at a constant level, the formation of fibers can be promoted, and the dryness, diameter, morphology and density of fibers to be spun can be modified.

What is claimed is:

1. An electro-spinning nozzle pack for receiving and then electro-spinning a solution with a fiber feedstock dissolved therein, comprising:
a body with a solution receiving space to keep the solution supplied;
a plurality of solution injection nozzles installed at the body in such a manner that the nozzles are in communication with the solution receiving space; and
a high-voltage electrode arranged inside the solution receiving space, for charging the solution therein.

2. The electro-spinning nozzle pack according to claim 1, wherein the body has a gas receiving space below the solution receiving space, for receiving gas, and wherein the electro-spinning nozzle pack further comprises a plurality of gas injection nozzles installed in such a manner that the solution injection nozzles having a one-to-one correspondence with the gas injection nozzles pass through the centers of the gas injection nozzles, respectively.

3. The electro-spinning nozzle pack according to claim 2, wherein the body has a gas inlet which is in communication with the gas receiving space, and extends towards the top surface of the body bypassing the solution receiving space.

4. The electro-spinning nozzle pack according to claim 1, wherein the high-voltage electrode has a plurality of openings arranged along the longitudinal direction of the body.

5. The electro-spinning nozzle pack according to claim 4, wherein the plurality of openings are arranged such that a spacing between the openings below the solution inlet is the largest, and then the spacing becomes gradually smaller for the openings located farther from the solution inlet.

6. The electro-spinning nozzle pack according to claim 1, wherein a gap between the solution injection nozzles located on both ends among the solution injection nozzles and the both end faces along the longitudinal direction of the body is half of the spacing between two neighboring solution injection nozzles.

7. An electro-spinning system comprising:
an electro-spinning nozzle pack for receiving and then electro-spinning a solution with a fiber feedstock dissolved therein, which comprises a body with a solution receiving space to keep a solution supplied, a plurality of solution injection nozzles installed at the body in such a way to be communicable with the solution receiving space, and a high-voltage electrode arranged inside the solution receiving space for charging the solution therein;
a solution supply block for supplying a solution to the solution receiving space;
a high-voltage providing block for applying a high voltage to the high-voltage electrode; and
a collector on which electrospun fibers from the plurality of solution injection nozzles are piled up.

8. The electro-spinning system according to claim 7, wherein the body of the electro-spinning nozzle has a gas receiving space below the solution receiving space, for receiving gas;
wherein the electro-spinning nozzle pack comprises a plurality of gas injection nozzles installed in the body in such a manner that the nozzles are in communication with the gas receiving space and the solution injection nozzles having a one-to-one correspondence with the gas injection nozzles pass through the centers of the gas injection nozzles, respectively; and
wherein the electro-spinning system further comprises an air supply block for supplying air to the gas receiving space.

9. The electro-spinning system according to claim 8, wherein the body has a gas inlet which is in communication with the gas receiving space, and extends towards the top surface of the body bypassing the solution receiving space.

10. The electro-spinning system according to claim 7, wherein the high-voltage electrode has a plurality of openings arranged along the longitudinal direction of the body.

11. The electro-spinning system according to claim 10, wherein the plurality of openings are arranged such that a spacing between the openings below the solution inlet is the largest, and then the spacing becomes gradually smaller for the openings located farther from the solution inlet.

12. The electro-spinning system according to claim 7, wherein a gap between the solution injection nozzles located on both ends among the solution injection nozzles and the both end faces along the longitudinal direction of the body is half of the spacing between two neighboring solution injection nozzles.

13. The electro-spinning system according to claim 7, wherein the air supply block includes a blower for forcefully sending a gas, and a heater for controlling the temperature of the gas.
